(19) United States
(12) Patent Application Publication
(10) Pub. No.: US 2019/0245749 A1
(43) Pub. Date: Aug. 8, 2019

(54) OPTIMIZING CLOUD RESOURCES FOR ABR SYSTEMS

(71) Applicant: Cisco Technology, Inc., San Jose, CA (US)

(72) Inventors: Gareth John BOWEN, Chandlers Ford (GB); Kevin A. MURRAY, Fordingbridge (GB)

(21) Appl. No.: 15/889,237

(22) Filed: Feb. 6, 2018

(51) Int. Cl. H04L 12/24; H04L 29/06

(52) U.S. Cl. CPC H04L 41/0896; H04L 67/10; H04L 65/80; H04L 65/4069

(57) ABSTRACT

In one embodiment, a method, system, and apparatus is described in which data is stored in a memory to be used by a processor. The processor performs the steps of allocating initial available bandwidth for adaptive bitrate (ABR) streaming over an ABR streaming network among a set of channels available to be streamed, optimizing at least one profile for at least one channel of the set of channels after the initial available bandwidth has been allocated, the optimizing being performed on the basis of a video quality metric, a viewing metric, and at least one of: a central processing unit (CPU) constraint, and a bandwidth constraint. The allocating and optimizing is repeated upon one of adding at least one channel to the set of channels, deleting at least one channel from the set of channels, changing available CPU capacity, and changing available bandwidth. Related methods, systems, and apparatus is also described.

### TECHNICAL FIELD

The present disclosure generally relates to systems, methods, and apparatus for adaptive bitrate streaming environments.

### BACKGROUND

Adaptive Bitrate Streaming is a technique used in streaming multimedia over computer networks. In the past most video streaming technologies used either file download, progressive download, or custom streaming protocols, while HTTP played a minor role in video streaming technologies. Today, however, most of adaptive streaming technologies are based on utilizing hypertext transfer protocol (HTTP) requests and methods to download content. HTTP requests and methods are designed to work efficiently over large distributed HTTP networks such as may be found on the Internet.

HTTP-based Adaptive Streaming (HAS) operates by tracking a user's bandwidth and device capabilities and capacities, and then selecting an appropriate representation (e.g., bandwidth and resolution) to stream to the user's device, among available bitrates and resolutions. Typically, HAS leverages the use of an encoder that can encode a single source video at multiple bitrates and resolutions, wherein said encoding can be representative of either constant bitrate encoding (CBR) or variable bitrate encoding (VBR). A player client can switch among the different encodings or representation depending on available resources. Ideally, the result of utilizing HAS is that there is little buffering, fast start times, and good video quality experiences for users having high-bandwidth connections and for users having low-bandwidth connections.

### BRIEF DESCRIPTION OF THE DRAWINGS

The present disclosure will be understood and appreciated more fully from the following detailed description, taken in conjunction with the drawings in which:

FIG. 1 is a simplified block diagram of a communication system for providing bitrate adaptation in adaptive bitrate streaming environments in accordance with one embodiment of the present disclosure:

FIG. 2 is a simplified partly block diagram partly pictorial illustration, illustrating a possible adaptive bitrate streaming scenario in accordance with the system of FIG. 1;

FIG. 3 is a flowchart of a method of operation of an embodiment of a system for bandwidth allocation and optimization of FIG. 1;

FIG. 4 is a simplified block diagram illustrating one embodiment of the system for bandwidth allocation and optimization for use in the system of FIG. 1;

FIG. 5 is a flowchart of a method for reallocation and re-optimization of bandwidth when adding (or deleting) a channel after performing the method of FIG. 3; and

FIG. 6 is a flowchart of a method of operation of an embodiment for use in the system of FIG. 1.

### DESCRIPTION OF EXAMPLE EMBODIMENTS

### Overview

In one embodiment, a method, system, and apparatus is described in which data is stored in a memory to be used by a processor. The processor performs the steps of allocating initial available bandwidth for adaptive bitrate (ABR) streaming over an ABR streaming network among a set of channels available to be streamed, optimizing at least one profile for at least one channel of the set of channels after the initial available bandwidth has been allocated, the optimization being performed on the basis of a video quality metric, a viewing metric, and at least one of: a central processing unit (CPU) constraint, and a bandwidth constraint. The allocation and optimization is repeated upon one of adding at least one channel to the set of channels, deleting at least one channel from the set of channels, changing available CPU capacity, and changing available bandwidth. Related methods, systems, and apparatus is also described.

### Exemplary Embodiments

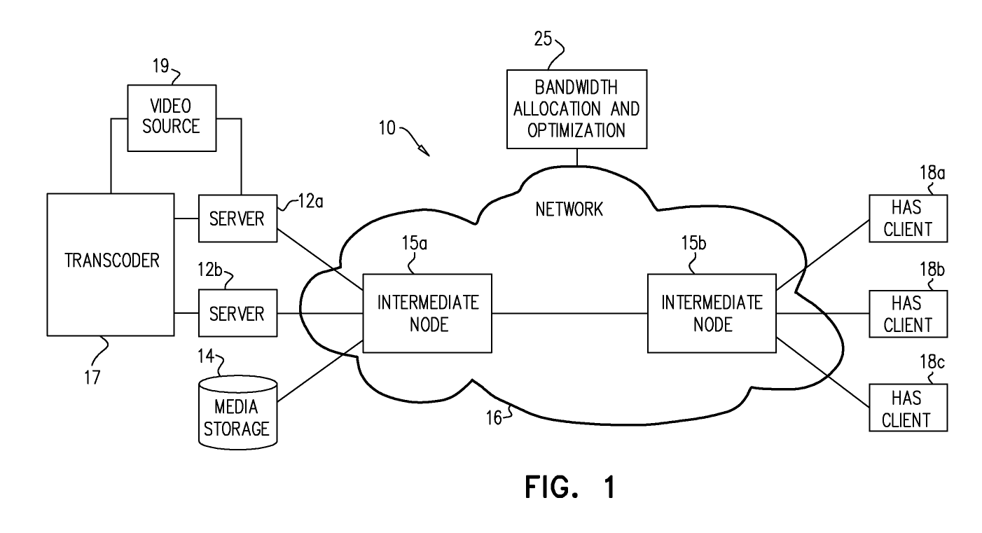

Reference is now made to FIG. 1, which is a simplified block diagram of a communication system 10 for providing bitrate adaptation in adaptive bitrate (ABR) streaming environments in accordance with one embodiment of the present disclosure. The communication system 10 of FIG. 1 is configured for providing bitrate adaptation for a plurality of HTTP-based Adaptive Streaming (HAS) clients 18 a-c. The Communication system 10 may include a plurality of servers 12 a-b, media storage 14, a network 16, an originating video source, the plurality of HAS clients 18 a-c, and a plurality of intermediate nodes 15 a-b. Note that the originating video source 19 may itself be provided to one (or more) of the servers 12a, or the video source may be provided to a transcoder 17 that takes a single encoded source (i.e. originating video source 19) and “transcodes” it into a plurality of content items at multiple bitrates, or the originating video source could be a “primary” encoder that takes an original non-encoded video source and directly produces the plurality of content items at multiple bitrates. Therefore, it is to be understood that transcoder 17 is representative of any appropriate type of multi-rate encoder, transcoder, etc.

The servers 12 a-b are configured to deliver content (e.g., video, audio, games, applications, channels, and programs) to HAS clients 18 a-c upon request of the HAS clients 18 a-c. The requested content may include any suitable information and/or data that can propagate in the network 16 (e.g., video, audio, media, metadata, any type of streaming information, etc.). Certain content may be stored in media storage 14, which can be located anywhere appropriate in the network 16. For example, media storage 14 may be a part of a Web server (not shown), or may be logically connected to one of servers 12 a-b, and may be suitably accessed using the network 16, etc. In general, the communication system 10 can be configured to provide downloading and streaming capabilities associated with various data services. The communication system 10 can also offer the ability to manage content for mixed-media offerings, which may combine video, audio, games, applications, channels, and programs into digital media bundles.

In ABR streaming, a source video is encoded such that multiple instances of the same content are available for streaming at a number of different bitrates. The multiple instances can be encoded via either multi-rate coding (e.g., H.264 AVC) or layered coding (e.g., H.264 SVC). Content for streaming to the HAS clients 18a-c can be divided into “segments” typically two (2) to ten (10) seconds in length. HAS clients 18a-c can access the segments stored on servers (or produced in near real time for live streaming) using a Web paradigm (e.g., HTTP GET operations over a TCP/IP transport), and the HAS clients 18a-c depend on the reliability, congestion control, and flow control features of TCP/IP for data delivery. HAS clients 18a-c can indirectly monitor the performance of fetch operations by monitoring a bitrate of video delivery received and/or a fill level of their receiving buffer. HAS clients 18a-c use performance in order to determine either:

upshift to a higher encoding bitrate to obtain better quality when bandwidth is available;

downshift in order to avoid buffer underruns and the consequent video stalls when available bandwidth decreases; or

otherwise stay at the same bitrate.

Compared to non-adaptive systems such as classic cable TV or broadcast services, adaptive streaming systems typically use significantly larger amounts of buffering to absorb the effects of varying bandwidth from the network.

In a typical ABR streaming scenario, HAS clients 18 a-c fetch content in segments from one of the servers 12 a-b. A segment can contain a portion of a program, typically comprising a few seconds of program content. (Note that the terms ‘segment’, ‘fragment’, and ‘chunk’ are often used interchangeably in the art. It is appreciated that this usage may be convenient at times, but is not necessarily precise, in that there are differences between how different ABR streaming protocols use these terms.)

With most adaptive streaming technologies, it is common practice to have segments represent the same, or very nearly the same, interval of program time. For example, in the case of some streaming protocols (e.g., MPEG DASH, (Dynamic Adaptive Streaming over HTTP)), it is common practice to have segments of a program represent almost exactly 2 seconds worth of content for the program. With HTTP Live Streaming (HLS), it is quite common practice to have segments of a program represent almost exactly 10 seconds worth of content. Although it is also possible to encode segments with different durations (e.g., using 6-second segments for HLS instead of 10-second segments), even when this is done, it is nevertheless common practice to keep as many segments as possible within a program of the same duration. In some cases segment duration may vary in order to support functionality such as advertisement substitution and other video substitutions as is known in the art.

The communication system 10 of FIG. 1 also comprises a system for bandwidth allocation and optimization 25, which will be discussed below in greater detail.

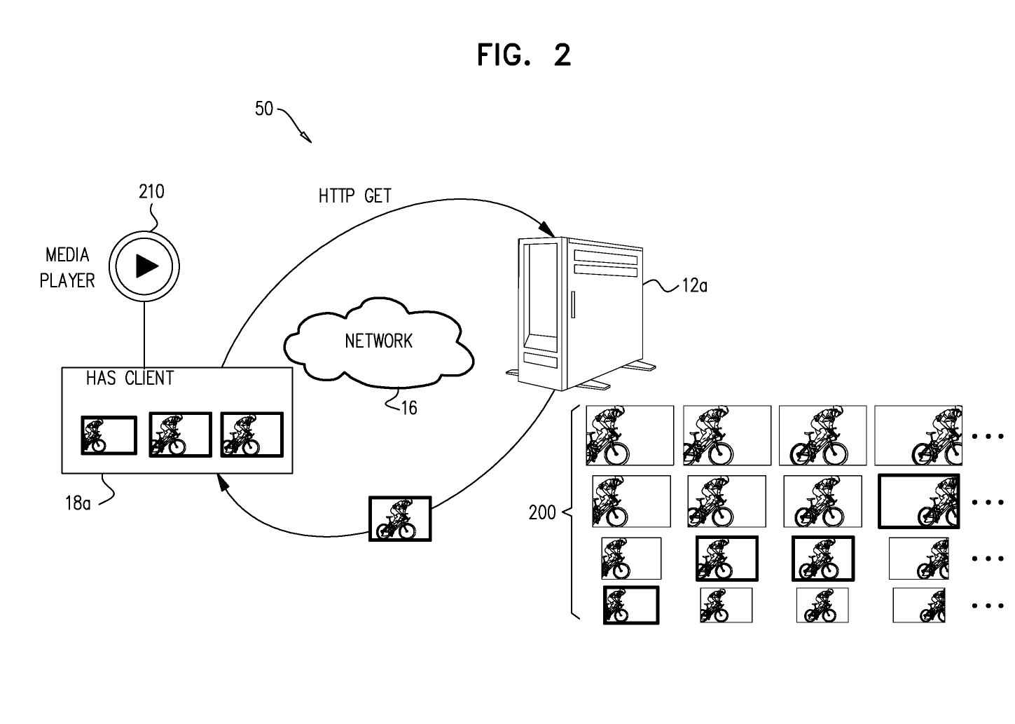

Reference is now made to FIG. 2, which is partly block diagram partly pictorial illustration, illustrating a possible adaptive bitrate streaming scenario in accordance with the system of FIG. 1. FIG. 2 depicts an environment 50 for providing adaptive video streaming over HTTP. The server 12a is able to provide, upon request, to client devices (such as HAS client 18a) a plurality of segments 200 each of which is available at differing encoding bitrates.

The HAS client 18a can download available segments of the plurality of segments 200 from the server 12a using HTTP GET operations, measure the available bandwidth based on download history, and select the video bitrate of the next segment on-the-fly based on video bitrates of available segments at the server 12a. Upon download, segments which are received are available for playing at a media player 210.

Typical ABR systems are configured with a static set of profiles (i.e., bandwidth, resolution, frame rate for video, and under some circumstances, language) common across channels. Generating a set of static starting points for the profiles is currently a challenging and slow process. As a result, operators often use a single set of profiles for content, or a very limited set of profiles, usually for different services (e.g. live linear versus cloud-based digital video recorder (DVR)). However, doing so ignores the potential for optimizations that may be achievable based on the actual or expected usage of any service.

Further, ABR systems are not actually static (which is an implicit assumption in a configuration mechanism which assumes that the configuration is static, such as is described above). Channel line-ups in ABR systems are frequently changed; network infrastructure is frequently being upgraded; viewing patterns and habits are changing; end devices and device counts are continually changing; encoder performance is frequently improving; the resource availability for encoding and delivery change; even input content can alter in its quality, complexity and make-up (e.g. amount of so-called “talking heads” and sport content, or up-converted vs native resolutions).

In principle, an operator has a maximum number of bits which can be transmitted over a given communication channel in a given amount of time, i.e., a set of “line speed data” for customers' fixed device consumption. A total of the line speed data represents a starting point for the process described herein below. (For a new provider, total of the line speed data would be based on an initial expectation for launch, for example, a projection based on registered interest and/or known rate distributions in target areas.)

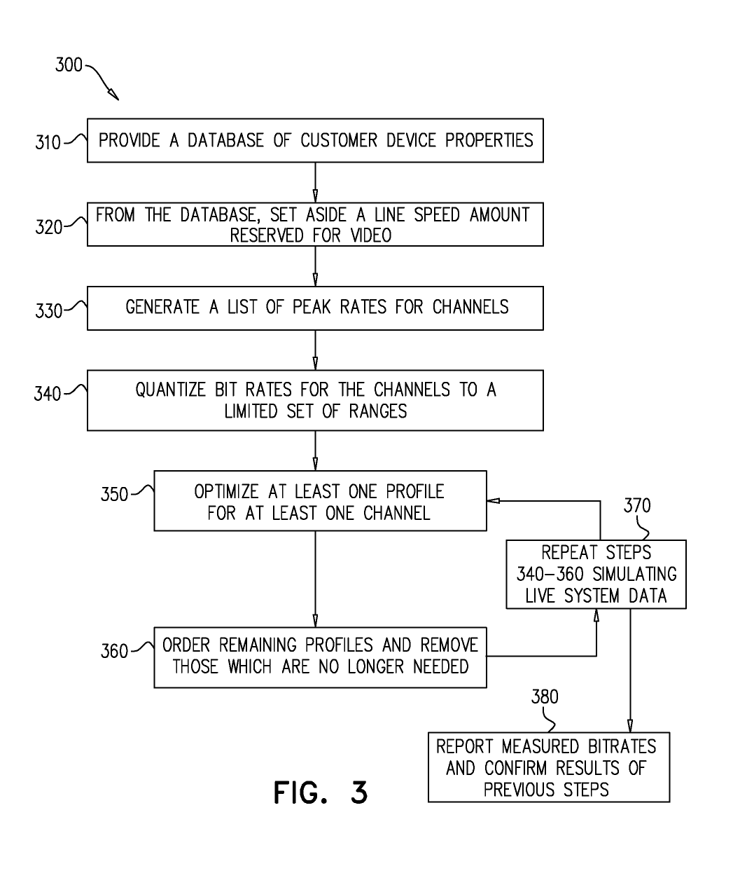

Reference is now made to FIG. 3, which is a flowchart 300 of a method of operation of an embodiment of the system for bandwidth allocation and optimization 25 of FIG. 1. At step 310, a database which stores customer device properties is provided. Specifically, an operator of a system which provides ABR services will typically have the set of line speed data for customer fixed device consumption (as described above).

At step 320, a line speed amount which is reserved for video is set aside from the database. By way of example, the set of line speed data for customer fixed device consumption might be reduced to an amount reserved for video (eliminating other data which might also be carried/delivered to known customer fixed devices from a total amount of available bandwidth).

As an optional step (not depicted in FIG. 3), where a household is known to stream multiple videos simultaneously, the line speed can be further reduced on a basis of a typical streaming pattern for the household, as desired by the operator. It is likely that this reduced line speed would be added to the set of line speeds rather than replacing the higher line speed. This reduction in line speed reflects the operation when a single channel is consumed by multiple devices. Multiple additions to the line speed could be made to reflect the expected numbers of multiple simultaneous videos that might be streamed.

As another optional step (not depicted in FIG. 3), where overall viewing patterns are known, the viewing patterns may then be used to map potential line speed rates to individual channels.

As a further optional step (not depicted in FIG. 3), where mobile (i.e., non-fixed device) consumption is known, the line speeds for mobile consumption are added to the list of rate/consumption possibilities. Optionally, the line speeds for mobile consumption may include line speeds of channels which are known to be (or likely to be) consumed on mobile devices. In some embodiments, users may be provided with incentives to run benchmarking or other test applications on their respective devices.

At step 330, a result of the above determinations is used to generate a list of peak rates for channels to be provided to user devices. In some embodiments, the list of peak rates may be generated for all possible channels at a given period.

In some embodiments, either as part of step 330, or following step 330, an operator would provide a list of “must have” rates for the channels, e.g. a lower quality bound and a higher quality bound. These rates (which may not be identical for each channel, but could be) would be added to the list for the channels, and flagged as “Target Rates”. Other desired rates may optionally be designated as flagged target rates as well. The lower quality bound is understood to refer to a profile allocated to a particular channel beneath which the operator would not want to provide the particular channel. For example, the quality beneath the lower quality bound profile for the particular channel may, at times, be so poor that should the channel be provided at that low a quality, the operator's reputation might be damaged.

The higher quality bound, by contrast, represents a profile above which, at any given time, no difference is noticed by a viewer, in light of a current state of available screen technology.

At step 340, bit rates for channels are quantized to a limited set of ranges. Starting with, for instance, a lowest flagged target rate, which may be the lower quality bound for a given channel (but in principle, may be a rate which will produce a higher quality than the lower quality bound profile), a “bucket” is marked at that rate, and higher bitrate capabilities that the quality information indicates would not be noticeably different (on a receiver's screen) are grouped down into that rate/bucket.

By way of example, if there is a flagged target rate of 10 Mbps, and there were other rates, e.g., 10.3, 10.5, 9.8, 7, 3.5, 12, 20 Mbps, and visual testing scores indicated that rates between 10 Mbps and 12 Mbps were indistinguishable, then a new list of 10 [i.e., the flagged target rate, where a count of 3 rates were indistinguishable from this rate of 10 Mbps], 9.8, 7, 3.5, 20 Mbps would be produced. This process may then be repeated to account for other flagged rates and/or buckets. Thus, if in this example, the lower quality bound profile calls for 3 Mbps, an end result of this process might produce the following list of sets of ranges: 10 [as above, the flagged target rate, where a count of 3 rates were indistinguishable from this rate of 10 Mbps], 7 [i.e., a count of 2 rates were indistinguishable from this rate of 7 Mbps], 3 [as above, a flagged lowest target rate], 20.

Persons of skill in the art will appreciate that an operator operating in constant quality mode will typically use quality rather than bitrate to define buckets, using a similar approach to the description of step 340 above.

Step 340 is repeated for any channels to which the operator desires to allocate bandwidth in this fashion.

At step 350, the channels to which bandwidth has been allocated in step 340 on the basis of video quality now undergo a further process of optimization based on a viewing metric and computer processing (i.e., central processing unit (CPU)) constraints. This step will be discussed below in greater detail. However, to provide a simple example, if the channel described above has the set of ranges: 3 Mbps, 7 Mbps, 10 Mbps, and 20 Mbps, a certain CPU capacity, say C₁, is required in order to provide computing resources for providing these bandwidths on the channel. Should the operator now wish to add an additional range of 15 Mbps, the required CPU capacity may now increase to C₂. However, the total available CPU capacity remaining for the operator after performing step 340 may be less than C₂, and thus, adding an additional range of 15 Mbps for the exemplary channel might not be possible (without adding additional CPU capacity).

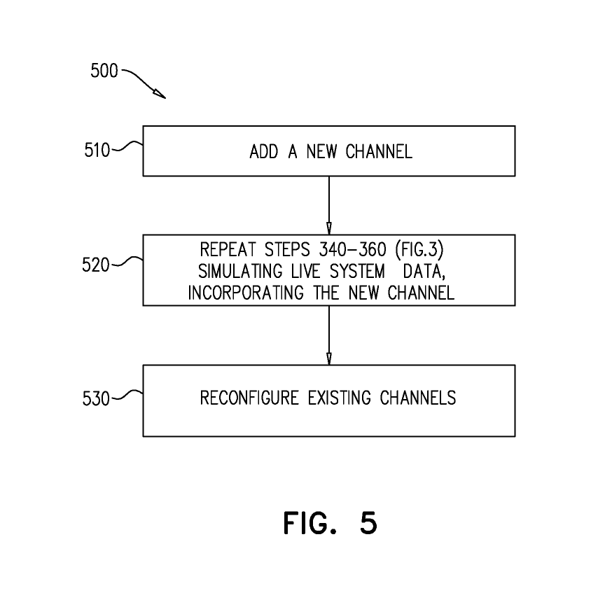

At step 360, the resulting profiles are ordered, and the profiles which are no longer needed are removed from the list of available profiles. Returning to the exemplary channel described above, the seven initial profiles: 10.3, 10.5, 9.8, 7, 3.5, 12, 20 Mbps would be ordered and reduced to 4 profiles: 3 Mbps, 7 Mbps, 10 Mbps, and 20 Mbps. The profiles at 10.3, 10.5, and 12 Mbps would be combined into the resultant 10 Mbps profile. Similarly, the 7 and 9.8 Mbps profile would be combined into the resultant 7 Mbps profile. The 3.5 Mbps profile would be reduced to what would be the lower quality bound profile of 3 Mbps. Persons of skill in the art will appreciate that calculations similar to CPU load may also be undertaken on total bandwidth, as will be described below, with reference to FIG. 5.

At step 370, the allocation and optimization (steps 340-360) are repeated using data from applications which are executed on client boxes that simulate the load and the behavior of real viewers (though there is no actual need to display the content). Typically this data would represent a statistically appropriate subset of an expected population of the real viewers. Alternatively, a remote cloud player could be used simulate the load and the behavior of real viewers (though this is not ideal). The remote cloud player would make use of a virtual private network (VPN) (or similar network) to locate its “input” as close as possible (from a networking point of view) to the point at which a player on an actual client player device would consume the data. This “input” originate from a digital subscriber line access multiplexer (DSLAM) or cable modem termination system (CMTS)—thereby approximating conditions to which the actual client player device would be subject. The player on the client boxes or the remote cloud player would then compensate for the expected connections by slowing down its read data rates to that of the expected end client line speed as defined above with reference to the description of FIG. 2.

The players mentioned in step 370 would report their measured bitrates, which would be used to confirm and/or to adjust the allocation and optimization as described above (step 380).

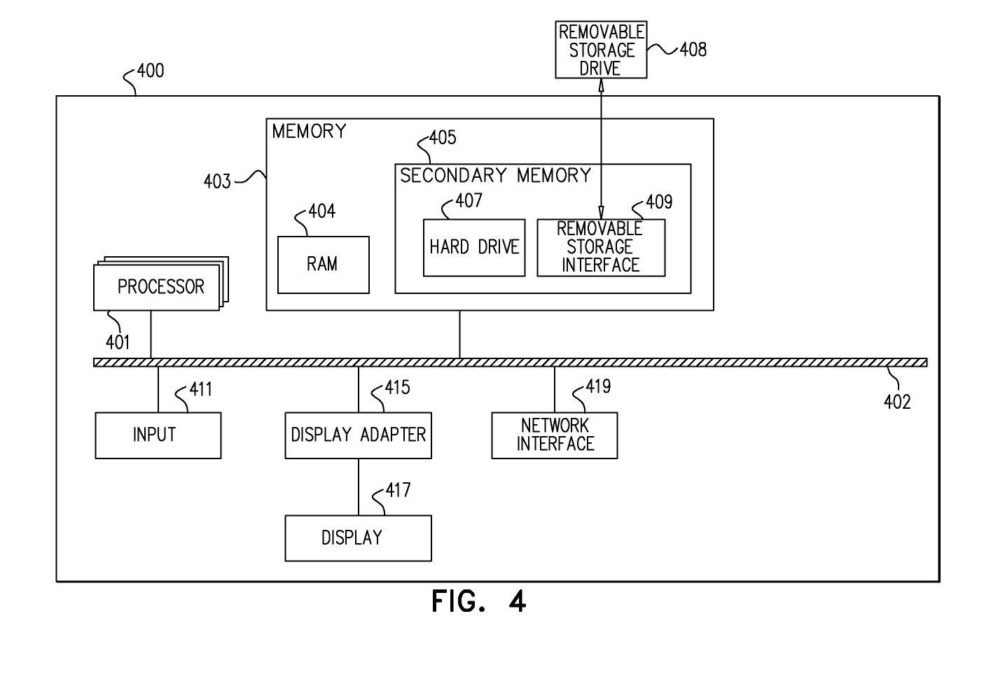

Reference is now made to FIG. 4, which is a simplified block diagram illustrating one possible embodiment of the system for bandwidth allocation and optimization 25 for use in the system of FIG. 1. An exemplary device 400 is depicted, illustrating an embodiment where a single apparatus implements the system for bandwidth allocation and optimization 25 of FIG. 1. In practice, the system for bandwidth allocation and optimization 25 of FIG. 1 may be implemented in a variety of fashions, including using distributed and virtual portions. Nonetheless, in practice, even if the system for bandwidth allocation and optimization 25 of FIG. 1 is a distributed application implemented across a variety of servers, in practice, it operates as described below.

The exemplary device 400 is suitable for implementing the systems, methods or processes described above. The exemplary device 400 comprises one or more processors, such as processor 401, providing an execution platform for executing machine readable instructions such as software. One of the processors 401 may be a special purpose processor operative to perform the method for ABR channel allocation and optimization described herein above. Processor 401 comprises dedicated hardware logic circuits, in the form of an application-specific integrated circuit (ASIC), field programmable gate array (FPGA), or full-custom integrated circuit, or a combination of such devices. Alternatively or additionally, some or all of the functions of the processor 401 may be carried out by a programmable processor or digital signal processor (DSP), under the control of suitable software. This software may be downloaded to the processor in electronic form, over a network, for example. Alternatively or additionally, the software may be stored on tangible storage media, such as optical, magnetic, or electronic memory media.

Commands and data from the processor 401 are typically communicated over a communication bus 402. The system 400 also includes a main memory 403, such as a Random Access Memory (RAM) 404, where machine readable instructions may reside during runtime, and a secondary memory 405. The secondary memory 405 includes, for example, a hard disk drive 407 and/or a removable storage drive 408, representing a floppy diskette drive, a magnetic tape drive, a compact disk drive, a flash drive, etc., or a nonvolatile memory where a copy of the machine readable instructions or software may be stored. The secondary memory 405 may also include ROM (read only memory), EPROM (erasable, programmable ROM), EEPROM (electrically erasable, programmable ROM). In addition to software, data representing customer device properties, channel data, bandwidth data, profile data, simulated live system data, and so forth, described above (for steps 310-380 of FIG. 3) without limiting the generality of the foregoing, or other similar data, may be stored in the main memory 403 and/or the secondary memory 405. The removable storage drive 408 reads from and/or writes to a removable storage interface 409 in a well-known manner.

A user can interface with the exemplary device 400 via a user interface which includes input devices 411, such as a touch screen, a keyboard, a mouse, a stylus, and the like, in order to provide user input data. A display adaptor 415 interfaces with the communication bus 402 and a display 417 and receives display data from the processor 401 and converts the display data into display commands for the display 417.

A network interface 419 is provided for communicating with other systems and devices via a network, e.g., the network 16 of FIG. 1. The network interface 419 typically includes a wireless interface for communicating with wireless devices in the wireless community. A wired network interface (e.g. an Ethernet interface) may be present as well. The exemplary device 400 may also comprise other interfaces, including, but not limited to Bluetooth, and HDMI.

It will be apparent to one of ordinary skill in the art that one or more of the components of the exemplary device 400 may not be included and/or other components may be added as is known in the art. The exemplary device 400 shown in FIG. 4 is provided as an example of a possible platform that may be used, and other types of platforms may be used as is known in the art. One or more of the steps described herein may be implemented as instructions embedded on a tangible computer readable medium and executed on the exemplary device 400.

Reference is now made to FIG. 5, which is a flowchart 500 of a method for reallocation and re-optimization of bandwidth when adding (or deleting) a channel after performing the method of FIG. 3. At step 510 the new channel is added. At step 520 steps 340-360 of FIG. 3 are repeated (as in step 370 of FIG. 3), however, the new channel is included. I.e., bit rates for channels, including a bit rate of the new channel (which was just added) are quantized to a limited set of ranges, as in step 340. Step 350 is repeated at least for the added channel, so that ABR profiles for the added channels undergo the optimization described in step 350. As in step 360, profiles which are no longer needed (including profiles for the added channel) are removed from the list of available profiles.

Step 520 is performed with the set of channels including the new channel, based on a full set of existing bandwidths, CPU, viewing quality information. Depending on the outcome of step 520, in step 530, some bitrates may be removed from some channels, and CPU resources may be re-allocated from one channel to another.

Channel removal may occur in a similar fashion, however, in such a case, in step 510, the channel is deleted rather than added. In step 520, the resources, such as bandwidth and CPU resources gained by removing the channel will be added back into a pool of resources which may be reallocated and re-optimized among remaining channels. In step 530, some bitrates may be added to some channels, and CPU resources may be re-allocated from one channel to another.

When performing system maintenance or updates, as in adding or removing a channel, steps 340-360 of FIG. 3 are repeated as in step 370 of FIG. 3. However, data is used from as large a population of the client players as is practical. Rather than using test applications to provide statistics such as bitrates and quality of received video, actual viewing data are used. These actual data would also include viewing patterns and statistics as well as actual numbers of simultaneous viewings, etc., that are the input to the processes described herein. The techniques described hereinabove can be run frequently, or can be run at intervals.

In view of the above discussion, in terms of CPU constraints, not using available CPU is an inefficiency which can be avoided using the methods and systems described herein. Similarly, balancing CPU load using the methods and systems as described herein might reduce a need to purchase additional computing power.

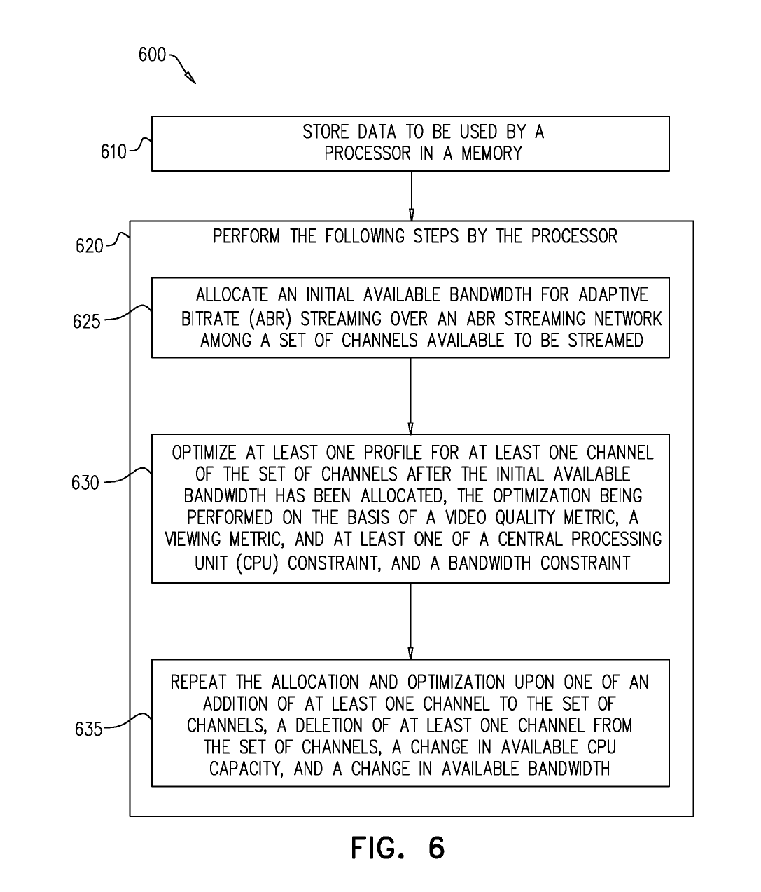

Reference is now made to FIG. 6, which is a flowchart 600 of a method of operation of an embodiment for use in the system of FIG. 1. At step 610 data is stored in a memory for use by a processor. At step 620 the following steps (steps 625-635) are performed by the processor:

An initial available bandwidth is allocated for ABR streaming over an ABR network among a set of channels to be streamed (step 625). At least one profile for at least one channel of the set of channels is optimized after the initial available bandwidth has been allocated, the optimization being performed on the basis of a video quality metric, a viewing metric, and at least one of a central processing unit (CPU) constraint, and a bandwidth constraint (step 630). The allocation and optimization steps (i.e. steps 625 and 630) are repeated upon one of: addition of at least one channel to the set of channels, deletion of at least one channel to the set of channels, a change in available CPU capacity, and a change in available bandwidth (step 635).

It is appreciated that in some embodiments, the system described hereinabove may be implemented without affecting a live video system. Rather, the system described hereinabove may be used as a tool for determining which resources to acquire. By way of example, a broadcast executive might wish to determine whether a portion of available budget is best used to increase available computing power or to increase available bandwidth. The system described hereinabove might be used to provide an analysis of the effect investing in different resources would have on the live broadcast system.

It is appreciated that the viewing metric (discussed above, at least with reference to step 630) may be determined as a result of visual testing of a profile. It is appreciated that the viewing metric may be determined by human observation of received video. Accordingly, two profiles which have undergone visual testing, and have a substantially similar viewing metric resulting from the visual testing, may be subject to optimization, as described herein above.

It is appreciated that software components of the embodiments of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present disclosure.

It is appreciated that various features of disclosed embodiments which are, for clarity, described in the contexts of separate embodiments may also be provided in combination in a single embodiment. Conversely, various features disclosed embodiments, which are, for brevity, described in the context of a single embodiment may also be provided separately or in any suitable subcombination.

It will be appreciated by persons skilled in the art that embodiments of the present disclosure are not limited by what has been particularly shown and described hereinabove. Rather the scope of embodiments of the invention is defined by the appended claims and equivalents thereof:

What is claimed is:

1. A system comprising:
a processor;
a memory for storing data to be used by the processor;
the processor being operative to:
perform an allocation of an initial available bandwidth among a set of channels for adaptive bitrate (ABR) streaming;
perform an optimization of at least one profile for at least one channel of the set of channels after the initial available bandwidth has been allocated, the optimization being performed on the basis of a video quality metric, a viewing metric, and at least one of:
a central processing unit (CPU) constraint; and
a bandwidth constraint; and
repeat the allocation and optimization upon at least one of:
an addition of at least one channel to the set of channels;
a deletion of at least one channel from the set of channels;
a change in available CPU capacity; and
a change in available bandwidth.

2. The system according to claim 1 wherein the allocation of initial available bandwidth includes allocation for a known consumption rate of remote player agents.

3. The system according to claim 1 wherein the allocation of initial available bandwidth includes an allocation of at least one profile having a lower quality bound for at least one channel of the set of channels.

4. The system according to claim 1 wherein the allocation of initial available bandwidth includes an allocation of at least one profile having a higher quality bound for at least one channel of the set of channels.

5. The system according to claim 1 wherein the allocation of initial available bandwidth is based, at least in part, on testing available bitrates by remote cloud players.

6. The system according to claim 1 wherein the optimization of the at least one profile for at least one channel includes combining a first profile having a first bitrate with a second profile having a bitrate lower than the first bitrate, on the basis of the first profile and the second profile having similar viewing metrics.

7. The system according to claim 6 wherein the viewing metric of the first profile and the viewing metric of the second profile are deemed similar on the basis of a result of visual testing of the first profile and second profile.

8. The system of claim 1 wherein the allocation and optimization are repeated continually.

9. A method comprising:
storing data in a memory to be used by a processor;
performing the following steps by the processor:
allocating initial available bandwidth for adaptive bitrate (ABR) streaming over an ABR streaming network among a set of channels available to be streamed;
optimizing at least one profile for at least one channel of the set of channels after the initial available bandwidth has been allocated, the optimizing being performed on the basis of a video quality metric, a viewing metric, and at least one of:
a central processing unit (CPU) constraint; and
a bandwidth constraint; and
repeating the allocating and optimizing upon one of:
adding at least one channel to the set of channels;
deleting at least one channel from the set of channels;
changing available CPU capacity; and
changing available bandwidth.

10. The method according to claim 9 wherein the allocating of initial available bandwidth includes allocating for a known consumption rate of remote player agents.

11. The method according to claim 9 wherein the allocating of initial available bandwidth includes allocating at least one profile having a lower quality bound for at least one channel of the set of channels.

12. The method according to claim 9 wherein the allocating of initial available bandwidth includes allocating at least one profile having a higher quality bound for at least one channel of the set of channels.

13. The method according to claim 9 wherein the allocating of initial available bandwidth includes testing available bitrates by remote cloud players.

14. The method according to claim 9 wherein the optimizing of the at least one profile for at least one channel includes combining a first profile having a first bitrate with a second profile having a bitrate lower than the first bitrate, on the basis of the first profile and the second profile having similar viewing metrics.

15. The method according to claim 14 wherein the viewing metric of the first profile and the viewing metric of the second profile are deemed similar on the basis of a result of visual testing of the first profile and second profile.

16. The method of claim 9 wherein the allocating and optimizing are repeated continually.

17. A system comprising:
means for storing data in a memory to be used by means for processing;
means for allocating, by the processor, an initial available bandwidth among a set of channels for adaptive bitrate (ABR) streaming;
means for by the processor, at least one profile for at least one channel of the set of channels after the initial available bandwidth has been allocated, the optimizing being performed on the basis of a video quality metric, a viewing metric, and at least one of:
a central processing unit (CPU) constraint; and
a bandwidth constraint; and
means for repeating the allocation and optimization upon one of:
adding at least one channel to the set of channels;
deleting at least one channel from the set of channels;
changing available CPU capacity; and
changing available bandwidth.

18. The system according to claim 17 wherein the allocating of initial available bandwidth includes allocation for a known consumption rate of remote player agents.

19. The system according to claim 17 wherein the allocating of initial available bandwidth includes an allocation of at least one profile having a lower quality bound for at least one channel of the set of channels.

20. The system according to claim 17 wherein the allocating of initial available bandwidth includes an allocation of at least one profile having a higher quality bound for at least one channel of the set of channels.
